(19) United States
(12) Patent Application Publication
(10) Pub. No.: US 2026/0126803 A1
(43) Pub. Date: May 7, 2026

(54) SYSTEM AND METHODS FOR VISUALIZATION OF CANOPY FORMATION FLIGHT

(71) Applicant: U.S. Army DEVCOM, Army Research Laboratory, Adelphi, MD (US)

(72) Inventor: Mahdi Al-Husseini, Enterprise, AL (US)

(73) Assignee: U.S. Government, as Represented by Secretary of the Army, Adelphi, MD (US)

(21) Appl. No.: 18/938,561

(22) Filed: Nov. 6, 2024

(51) Int. Cl. G05D 1/461; G05D 1/695

(52) U.S. Cl. CPC G05D 1/461; G05D 1/695

(57) ABSTRACT

Various embodiments are directed to systems, apparatus and methods for synthetic visualization of a canopy formation flight, such as used for training of a parachutist freefall team, planning of a mission for such a team, and the like. In particular, various embodiments provide systems and methods utilizing networked data recording systems distributed among a parachute canopy formation to capture relevant data and a computing device to synthetically visualize the canopy formation, provide recommendations for training purposes following the completion of a jump, and so on.

### GOVERNMENT INTEREST

The invention described herein may be manufactured and used by or for the Government of the United States for all governmental purposes without the payment of any royalty.

### FIELD OF THE DISCLOSURE

The present disclosure relates generally to synthetic visualization of a canopy formation flight and, more particularly, capturing individual parachutist data for visualizing the canopy formation flight and components thereof for various purposes.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Parachute canopy formation flight involves the organized assembly and movement of parachutists under canopy in proximity. The practice of establishing these canopy formations is typically known as canopy relative work and is of interest to both competitive skydivers and military freefall teams.

Free fall parachutists exit an aircraft within seconds of one another and regroup while in freefall or following canopy deployment. Free fall operations in which canopy deployment occurs at high altitudes are known as High Altitude High Opening (HAHO) operations, or standoffs. Standoffs are tactically significant in that they permit free fall parachutists to exit the aircraft upwards of tens of kilometers from the desired impact point (DIP), which may allow the aircraft to remain beyond the air defenses of the enemy to ensure secrecy of the operation.

The free fall parachutist team then navigates in formation under canopy through the sphere of enemy air defenses until arriving at the DIP to continue follow-on operations on the ground. Free fall parachutists utilize larger canopies with significant glide ratios to increase their ability to orient and track to a DIP from a far-off distance.

A freefall team's ability to maintain a tight canopy formation to the DIP is essential for both safety and control. A canopy formation with significant vertical or horizontal spacing may be at increased risk for enemy detection due to a larger overall in-air footprint. Similarly, minimizing the amount of time in which parachutists are on approach to the DIP reduces the amount of time parachutists are easily visible from the ground level. Finally, ensuring each parachutist remains within proximity and in-view reduces the risk of unforeseen canopy collisions or a lost parachutist, especially during nighttime operations.

Canopy relative work is simultaneously an individual and collective effort. The ability of each parachutist to control the forward glide and vertical descent of their parachute through strategic manipulation of flight controls to include trim tabs, rear risers, front risers, toggles, and body position, allows the overall stack to maintain its composure. Similarly, the overall team must be appropriately briefed on in-air techniques and mission contingencies and must also plan the exit weights of each parachutist and their corresponding fall-rates. Tight and organized canopy formations come about through well-trained individual jumpers with enough awareness and capability to first attain a position in a developing stack, and then maintain it, and through the kind of team cohesion built through repetition and with significant experience.

### SUMMARY OF THE INVENTION

Various deficiencies in the prior art are addressed below by the disclosed systems and method for synthetic visualization of a canopy formation flight, such as used for training of a parachutist freefall team, planning of a mission for such a team, and the like. In particular, various embodiments provide systems and methods utilizing networked data recording systems distributed among a parachute canopy formation to capture relevant data and a computing device to synthetically visualize the canopy formation, provide recommendations for training purposes following the completion of a jump, and so on.

The various embodiments assist canopy formation teams in tightening their formations by visualizing their in-air movements, such as to critique individual or team performance after a jump, or to plan a jump in accordance with specific flight path parameters, topological parameters, enemy or other threat parameters and so on.

Various embodiments contemplate networked data recording systems including respective GPS, altitude sensors, accelerometers, and gyroscopes embedded with (carried by) each parachutist in the canopy formation. The combination of GPS and altitude sensors allow for the recreation of the overall stack position. The inclusion of inertial sensors indicate turns and techniques applied by the parachutist, to attain and maintain stack position. The data is aggregated and then synthetically visualized using a computing device on the ground, which may further provide recommendations regarding the ordering of parachutists based on exit weight and historical data. The synthetic visualization of a canopy formation may greatly enhance the canopy relative work of a freefall formation team and thereby enhance military free fall insertion operations.

One embodiments is a synthetic visualization system for a parachute canopy formation flight traversing a flight path and including at least two parachutists, the system, comprising: a data recording system stowed with each parachutist under canopy in the parachute canopy formation, each data recording system comprising: a global positioning system (GPS) sensor; an altitude sensor; a plurality of accelerometers, each accelerometer associated with a respective axis of motion; a plurality of gyroscopes, each gyroscope associated with a respective axis of motion; and a memory for maintaining data collected from the GPS sensor, altitude sensor, accelerometers, and gyroscopes; and a computing device configured to generate a graphical representation of the canopy formation flight; wherein each parachutist under canopy is graphically represented relative to the overall canopy formation flight, the graphical representation of each parachutist under canopy comprising respective identifying, orientation, altitude, and velocity data; wherein the generated graphical representation depicts, for any parachutist under canopy, respective progress along the flight path from parachute deployment to arrival at a desired impact point.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a block diagram of a canopy formations flight data recording and visualizing system in accordance with an embodiment.

FIG. 2 depicts a flow diagram of a method of operation of a data recording system suitable for use in the system of FIG. 1;

FIG. 3 depicts a flow diagram of a method of operation of a visualizing system suitable for use in the system of FIG. 1; and

FIG. 4 depicts an exemplary synthetic post-jump visualization of a canopy formation, in accordance with an embodiment of the present invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments, such as seismology and data fusion.

Various deficiencies in the prior art are addressed below by the disclosed systems and method for synthetic visualization of a canopy formation flight, such as used for training of a parachutist freefall team, planning of a mission for such a team, and the like. In particular, various embodiments provide systems and methods utilizing networked data recording systems distributed among a parachute canopy formation to capture relevant data and a computing device to synthetically visualize the canopy formation, provide recommendations for training purposes following the completion of a jump, and so on.

The various embodiments assist canopy formation teams in tightening their formations by visualizing their in-air movements, such as to critique individual or team performance after a jump, or to plan a jump in accordance with specific flight path parameters, topological parameters, enemy or other threat parameters and so on.

Various embodiments contemplate networked data recording systems including respective GPS, altitude sensors, accelerometers, and gyroscopes embedded with (carried by) each parachutist in the canopy formation. The combination of GPS and altitude sensors allow for the recreation of the overall stack position. The inclusion of inertial sensors indicate turns and techniques applied by the parachutist, to attain and maintain stack position. The data is aggregated and then synthetically visualized using a computing device on the ground, which may further provide recommendations regarding the ordering of parachutists based on exit weight and historical data. The synthetic visualization of a canopy formation may greatly enhance the canopy relative work of a freefall formation team and thereby enhance military free fall insertion operations.

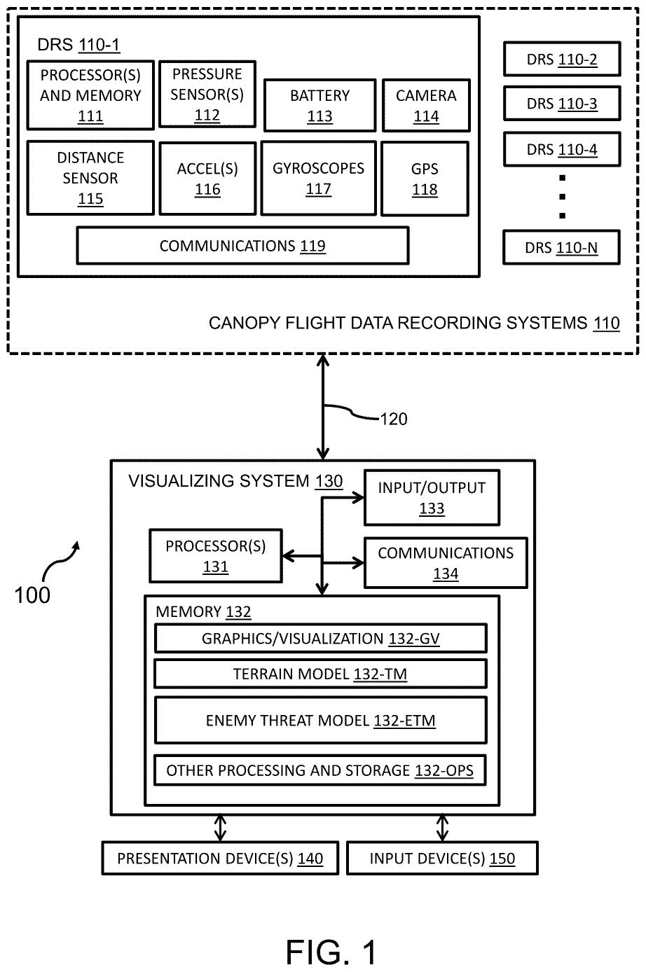

FIG. 1 depicts a block diagram of a canopy formations flight data recording and visualizing system in accordance with an embodiment. The canopy formations flight data recording and visualizing system 100 of FIG. 1 comprises one or more data processing elements, computing devices, network elements and the like cooperating as described herein to implement various embodiments. Not all of the described data processing elements, computing devices, network elements, sensing devices and the like are necessary to implement each embodiment. The exemplary system described herein is provided for illustrative purposes only. Portions of the system 100 of FIG. 1 may be implemented via one or more servers, workstations, data centers and/or other computing and memory providing devices operating in accordance with the various embodiments, such as described herein and with respect to the various other figures.

Specifically, FIG. 1 depicts a block diagram 100 showing the components of an exemplary canopy formations flight data recording and visualizing system; namely, a plurality of canopy flight data recording systems (CFDRSs) 110-1 through 110-N (collectively denoted as CFDRSs 110), each of which is in persistent or intermittent wireless communication with a visualizing system 130 via a wireless channel or link 120. It is noted that each of a plurality of parachutists in a canopy is associated with at least one respective CFDRS 110.

### Canopy Flight Data Recording Systems

As depicted in FIG. 1, each of the canopy flight data recording systems (CFDRSs) 110 comprises, illustratively, one or more processors/memory 111 (e.g., a computing device), battery 113, one or more accelerometers 116, one or more gyroscopes 117, a global positioning system (GPS) sensor/receiver 118, optional one or more pressure sensors 112, optional distance sensor 115, optional camera or other imaging device 114, communications interface 119, and so on.

Battery 113 may be an internal battery whose electrical specifications are designed to support various data recording system 110 subcomponents for a period no shorter than the length of a HAHO jump at maximum altitude. Processor 111 may consist of any combination of logical circuitry capable of processing digital information to include ASICs, GPUs, DPUs, and more, may access memory 112, which may consist of any combination of volatile and non-volatile memory to include ROM, EPROM, EEPROM, flash memory, DRAM, and more. Processor 111 may execute instructions stored in memory 112. Memory 112 must be large enough to store collected inertial, altitude, and distance data, along with imagery and video, for a period no shorter than the length of a HAHO jump at maximum altitude, regardless of collection rate frequency.

Camera 114 may include one or more cameras strategically positioned to capture the ongoing adjustment of canopy controls by the jumper to include front risers, rear risers, and trim tabs. Camera 114 may further capture the body position of the jumper (a smaller body position results in less drag, which can be adjusted to control forward glide) and the canopy overhead itself. Distance sensors 115 may use Bluetooth triangulation or ultrasonic sensing to determine relative position to other distance sensors or jumpers. An inertial measurement unit encompassing a three-axis accelerometer 116 and three-axis gyroscope 117, paired with a GPS sensor 118, indicates, after processing, a jumper's orientation, position, and altitude. A barometric pressure sensor may be added to data recording system 110 to improve altitude reading precision.

The inertial, altitude, location, distance, and other collected data may be timestamped and stored in memory 112. This data is exported/transmitted via wireless channel or link 120 to visualizing system 130, which is configured to generate various visualizations as will be discussed in more detail below, which visualizations may optionally include further information such as from a terrain model overlay, and enemy threat overlay, and so on.

The wireless channel or link 120 may comprise any suitable wireless channel or link, such as via radio frequency (RF) communications, optical communications, and so on (e.g., 802.11x, WiMAX, 4G/LTE, 5G, and the like). The wireless channel or link 120 may include, for example, wireless local area network (WLAN), wireless personal area network (WPAN), wireless metropolitan area network (WMAN), wireless wide area network (WWAN), satellite-based networks, or any combination thereof.

### Visualizing System 130

As shown in FIG. 1, the visualizing system 130 is depicted as being implemented using a computing device configured to perform the various functions described herein and comprising one or more processors 131, memory 132, input/output 133, and communications interface 134. Although primarily depicted and described as having specific types and arrangements of components, it will be appreciated that any other suitable types and/or arrangements of components may be used for visualizing system 130.

The input/output (I/O) resources or interface(s) 133 are configured to enable communication between the visualizing system 130 and various presentation devices 140 and/or input devices 150. For example, the I/O resources or interface(s) 133 may be coupled to one or more presentation devices (PDs) 140 such as display devices suitable for use in displaying or presenting information to a user, one or more input devices (IDs) 150 such as touch screen or keypad input devices for enabling user input, and/or interfaces enabling communication between the visualizing system 130 and other computing, networking, presentation or input/output devices (not shown).

Presentation devices 140 may include a display screen, a projector, a printer, one or more speakers, and the like, which may be used for displaying data, displaying video, playing audio, and the like, as well as various combinations thereof, an application programming interface (API) configured to support the presentation of data, and so on. The typical presentation interfaces associated with user devices, including the design and operation of such interfaces, will be understood by one skilled in the art.

Input devices (ID) 150 may include any user control devices suitable for use in enabling a local or remote user of the visualizing system 130 to interact with the visualizing system 130. For example, the input devices 150 may include touch screen based user controls, stylus-based user controls, a keyboard and/or mouse, voice-based user controls, and the like, as well as various combinations thereof. The typical user control interfaces of user devices, including the design and operation of such interfaces, will be understood by one skilled in the art.

The communications resources 134 are configured to enable communication between the visualizing system 130 and wireless channel or link 120.

As shown in FIG. 1, the memory 132 of the visualizing system 130 is used to implement various processors or modules in accordance with the embodiments, including a graphics/visualization processor 132-GV, an optional terrain model 132-TM, and optional enemy threat model 132-ETM, and various other processing and storage elements/modules 132-OPS. These processors, modules, or elements will be discussed in more detail below.

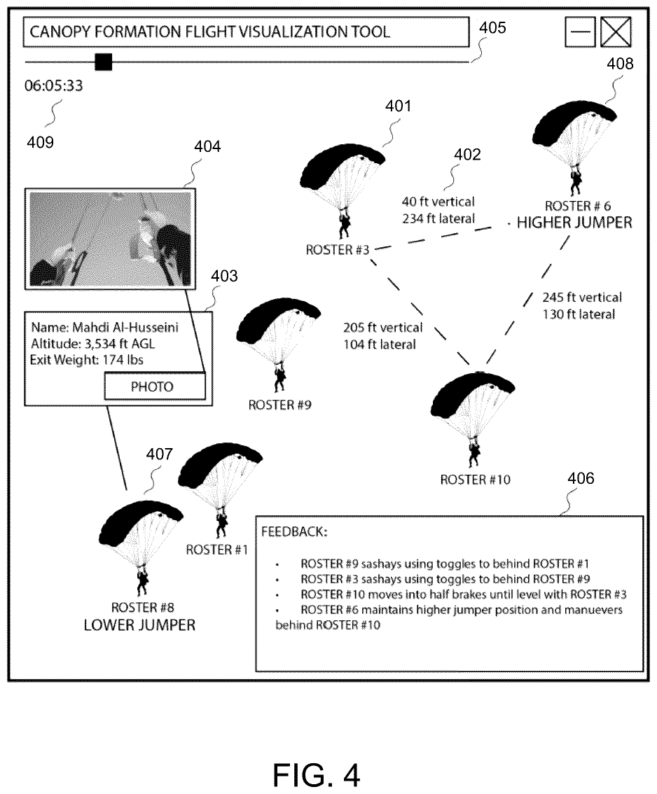

Generally speaking, in some embodiments the graphics/visualization processor 132-GV is configured to generate canopy and parachutist visualizations such as discussed below with respect to FIGS. 3 and 4.

Various elements or portions thereof depicted in FIG. 1 and having functions described herein are implemented at least in part as computing devices having communications capabilities, including in support of the CFDRS 110, wireless communications channel, link, or network 120, visualizing system 130, and any portions thereof. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using network equipment used to implement network functions at a network core, network equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The network equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

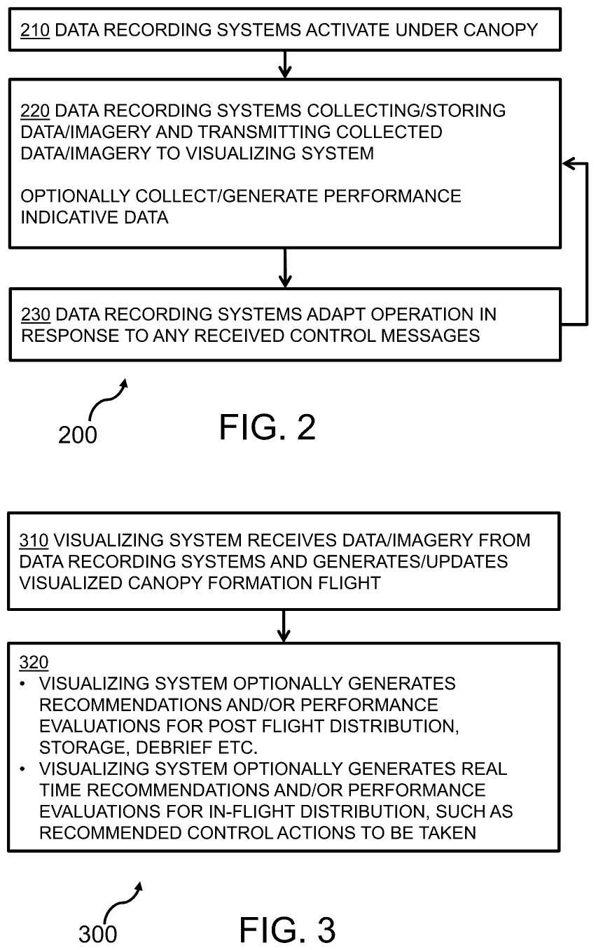

FIGS. 2-3 depict flowcharts illustrating an example of the process through which canopy formation data is collected and visualized during and after a jump, in accordance with an embodiment of the present invention.

FIG. 2 depicts a flow diagram of a method of operation of a canopy flight data recording system (CFDRS) 110 suitable for use in the system of FIG. 1. Specifically, the method 200 of FIG. 2 depicts an example of a process through which canopy formation data is collected during a jump via each of a plurality of CFDRS 110 to later develop via the visualizing system 130 one or more visualizations. The visualizations will be discussed in more detail below with respect to FIG. 4.

At 210, one or more CFDRS 110 placed with each jumper in the formation are activated following canopy deployment. CFDRS 110 may be activated by hand using a push button, toggle switch, or similar (e.g., as part of a parachute deployment motion), or may be automatically activated using inertial and altitude data to sense the dramatic acceleration and altitude change.

At step 220, the now activated CFDRS 110 begins to collect data/imagery such as location related data (e.g., via the GPS receiver 118), orientation related data (e.g., via the gyroscopes 117), and velocity related data (e.g., via the accelerometers 116). If implemented, the now activated CFDRS 110 further begins to collect altitude related data (e.g., via the pressure sensor(s) 112), fellow jumper distance data (e.g., via the distance sensor(s) 115), and photograph/video data (via the camera(s) 114). The collected data/imagery is stored in memory 111 and transmitted to the visualizing system 130 as discussed herein. The collected data/imagery may be transmitted to the visualizing system 130 contemporaneously with the data/imagery being received or stored in memory for a period of time (or until memory utilization reached a predetermined level) and then transmitted.

Optionally at step 220, CFDRS 110 collects and/or generates performance indicative data for at least one parachutist under canopy (or some or all of the parachutists), and/or for the canopy formation as a whole. Performance indicative data may comprise any type of data useful in assessing the flight or control characteristics of the canopy flight and/or its parachutists, the attitude, engagement, settings, or health of the equipment associated with the canopy flight and/or its parachutists (e.g., altitude, speed, orientation, control settings and the like), any monitored health data of the parachutists, and/or other data. Examples of individual parachutist performance data include average distance from expected position as determined by the position of other formation jumpers, “smoothness” of flight (as opposed to leading, then lagging behind, then leading again in a sort of oscillatory pattern), pull altitude accuracy (if jumper was to pull at 10,000 and instead pulled at 9,500, that would be a deficiency). A lot of that same information can be gathered and aggregated across the entire formation. There are more examples, but those are a few.

Other noteworthy training exercise parameters may be tied into terrain and enemy simulation for collision and threat avoidance for mission success. Compliance with training exercise parameters may be assessed, such as adherence to simulated (assumed) ground level, terrain features such as mountains or valleys, enemy air defense threats to be avoided by maneuver, and/or other simulated challenges.

At step 230, the CFDRS 110 adapts its operation in response to any received control messages. For example, in various embodiments, the frequency with which this data is collected may be fixed, adjusted by the jumper on the ground, and/or adjusted via a control message sent to the relevant CFDRSs via the wireless channel or link 120 (e.g., such as remote or local user issuing a command message via the visualizing system 130). Other control messages may be used to activate or deactivate the CFDRS 110, change parameters associated with various onboard sensors/devices, and so on.

FIG. 3 depicts a flow diagram of a method of operation of a visualizing system suitable for use in the system of FIG. 1.

At step 310, data/imagery collected by the various CFDRSs 110 is received by the visualizing system 130 and used to generate or update a visualized canopy formation flight. Specifically, the received data/imagery is processed by the graphics/visualization processor 132-GV to generate thereby visualization imagery such as depicted herein with respect to FIG. 4. Step 310 may optionally use any performance indicative data collected or generated by the CFDRS 110 of one or more parachutists in the canopy formation.

At step 320, the visualizing system 130 optionally generates post-flight performance evaluations and/or recommendations associated with one or more of the parachutists or with the canopy formation flight itself. These recommendations/evaluations may be provided to individual parachutists or team leaders, to a remote database for storing canopy flight log data, and to on.

In some embodiments, the visualizing system 130 optionally generates substantially real-time performance evaluations and/or recommendations associated with one or more of the parachutists or with the canopy formation flight itself. These recommendations/evaluations may be transmitted to the respective CFDRS(s) 110 associated with the one or more of the parachutists. For example, in-flight recommendations may comprise indications of specific parachute control or handling actions for a parachutist to execute. In this manner, recommendations, feedback, and guidance are provided to the stack on their most recent jump through visualization. Step 320 may optionally use any performance indicative data collected or generated by the CFDRS 110 of one or more parachutists in the canopy formation. An exemplary synthetic post-jump visualization of a canopy formation is discussed below with respect to FIG. 4.

A canopy formation flight may include each parachutist under canopy being visualized relative to the overall formation, along with the inclusion of identifying information to include orientation, altitude, and velocity, and wherein progress along the flight path of each parachutist under canopy may be displayed dynamically from parachute deployment to arrival at the desired impact point.

In various embodiments, the synthetic visualization of the canopy formation flight generates performance data suitable for use in evaluating the performance of one or more parachutists in the canopy formation, and/or the overall canopy formation.

In various embodiments, the synthetic visualization of the canopy formation flight generates recommendations for improving performance on subsequent canopy formation flights.

In various embodiments, the synthetic visualization of the canopy formation flight generates substantially real-time control recommendations for one or more parachutists during the canopy formation flight.

The information on CFDRS(s) 110 may be cleared in preparation for the next jump or may be overwritten once the next jump occurs as determined by inertial and altitude data.

Generally speaking, the methods 200 of FIG. 2 and 300 of FIG. 3 contemplate systems and methods for the synthetic visualization of a parachute canopy formation flight, the systems and methods configured for collecting time-synchronized inertial, position, and altitude data from a data recording system stowed with each parachutist in a canopy formation flight; downloading the time-synchronized data from each data recording system to a single computing system; and visualizing the canopy formation flight by importing the time-synchronized data into a graphics software engine on the computing system. In this manner, compliance with the rules/boundary conditions of training exercises and the like may be assessed for parachutists individually and as a part of the canopy formation.

FIG. 4 depicts an exemplary synthetic post-jump visualization of a canopy formation, in accordance with an embodiment of the present invention. Specifically, FIG. 4 illustrates an example of a synthetic post-jump visualization (e.g., as displayed upon a presentation device 140) of a canopy formation 400, in accordance with an embodiment of the present invention, such as generated by the visualizing system 130 in response to data received from the CFDRSs 110.

Visualization 400 depicts each jumper with a respective identifying roster number 401 in the stack, in either two or three-dimensions, with special designation provided to lower jumper 407 and higher jumper 408. The lower jumper 407, colloquially known as the low man, and the higher jumper 408, colloquially known as the high man, have special organization and control responsibilities in the stack. The lower jumper 407 will typically “pick-up” the stack by beginning an initial turn towards and in front of the subsequent and higher jumpers, whereas the higher jumper 408 will provide command and control of the stack, given his or her increased altitude and therefore increased ability to see all jumpers in the stack. Designating the lower and higher jumper in visualization 400 also helps indicate when a third jumper becomes lower than the designated lower jumper or higher than the designated higher jumper, in which case other procedures must be performed.

Each jumper 401 may be selected (e.g., via local or remote user input) in visualization 410 to bring up information box 403, which provides jumper information to illustratively include name, altitude, and exit weight, as well as an option to view a photograph or video clip 404 of the canopy controls taken at or near the corresponding timestamp 409 (assuming optional camera or imaging device 114 is implemented for that jumper). Viewing a photograph or video clip of the canopy controls can help identify which technique a jumper is using to maintain their position in the stack, whether that be sashaying, 50% brakes, 100% brakes, front riser application, or otherwise. The user of visualization 400 can adjust timestamp 409 through an interactive time bar 405 which ranges from as early as the lower jumper's canopy deploying, and as late as the last jumper arriving at the DIP. The vertical and lateral distance 402 between each jumper 401 may be selectively displayed to determine the extent to which certain distance requirements (typically 50-100 feet above and behind) between jumpers are met. An informational feedback box 406 provides timestamp specific guidance to each jumper to transform the current canopy formation to its ideal and organized form. Any of the information discussed in FIG. 4 may be selectively toggled on and off as required by the user. Additional visualization options include the integration of enemy threat rings, the depiction of joint precision airdrop systems (JPADS), and terrain models, such as described in more detail above.

Various embodiments provide a system for the synthetic visualization of a parachute canopy formation flight, the system comprising: one or more data recording systems stowed with each parachutist under canopy in a canopy formation, each data recording system possessing: a GPS sensor for determining parachutist position; one or more pressure sensors; a plurality of accelerometers, each providing an output with respect to a different axis; and a plurality of gyroscopes, each providing an output with respect to a different axis; a processor, wherein the processor is operative to determine parachutist orientation as a function of the outputs of the gyroscopes, and to estimate parachutist velocity and altitude as a function of the outputs of the accelerometers and one or more pressure sensors; memory for maintaining data collected from the GPS sensor, altitude sensor, accelerometers, and gyroscopes, and processed by the processor; and a computing device capable of synthetically visualizing the canopy formation flight in 3D using data from one or more data recording systems, the computing device, comprising a graphics software engine for the synthetic visualization of the canopy formation flight, wherein each parachutist under canopy is visualized relative to the overall formation, along with identifying information to include orientation, altitude, and velocity, and wherein progress along the flight path of each parachutist under canopy may be displayed dynamically from parachute deployment to arrival at the desired impact point. Each data recording system may further comprise one or more distance sensors designed to determine distance from each other data recording system in the canopy formation. The computing device may further comprise a terrain model overlay for inclusion into the synthetic visualization of the canopy formation flight. The computing device may further comprise an enemy threat model overlay for inclusion into the synthetic visualization of the canopy formation flight. The synthetic visualization of the canopy formation flight may further provide recommendations throughout the duration of flight regarding appropriate canopy control inputs for each parachutist. The synthetic visualization of the canopy formation flight may further provide data regarding the performance of each parachutist in the canopy formation, as well as the performance of the overall canopy formation.

Various embodiments provide a method for the synthetic visualization of a parachute canopy formation flight, the method comprising collecting time-synchronized inertial, position, and altitude data from a data recording system stowed with each parachutist in a canopy formation flight; downloading the time-synchronized data from each data recording system to a single computing system; and visualizing the canopy formation flight by importing the time-synchronized data into a graphics software engine on the computing system. The inertial data may be collected using any combination of one or more accelerometers and gyroscopes. The position data may be collected using any combination of one or more GPS and pressure sensors. The altitude data may be collected using any combination of one or more GPS and pressure sensors. Visualizing the canopy formation flight includes each parachutist under canopy being visualized relative to the overall formation, along with the inclusion of identifying information to include orientation, altitude, and velocity, and wherein progress along the flight path of each parachutist under canopy may be displayed dynamically from parachute deployment to arrival at the desired impact point.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A synthetic visualization system for a parachute canopy formation flight traversing a flight path and including at least two parachutists, the system, comprising:
a data recording system stowed with each parachutist under canopy in the parachute canopy formation, each data recording system comprising:
a global positioning system (GPS) sensor;
an altitude sensor;
a plurality of accelerometers, each accelerometer associated with a respective axis of motion;
a plurality of gyroscopes, each gyroscope associated with a respective axis of motion; and
a memory for maintaining data collected from the GPS sensor, altitude sensor, accelerometers, and gyroscopes; and
a computing device configured to generate a graphical representation of the canopy formation flight;
wherein each parachutist under canopy is graphically represented relative to the overall canopy formation flight, the graphical representation of each parachutist under canopy comprising respective identifying, orientation, altitude, and velocity data;
wherein the generated graphical representation depicts, for any parachutist under canopy, respective progress along the flight path from parachute deployment to arrival at a desired impact point.

2. The system of claim 1, wherein each data recording system further comprises a respective controller configured to determine parachutist orientation in response to data collected from the gyroscopes, to estimate parachutist velocity in response to data collected from outputs of the accelerometers, and to estimate altitude in response to data collected from the pressure sensor.

3. The system of claim 1, wherein each altitude sensor comprises one or more pressure sensors.

4. The system of claim 2, wherein each data recording system further comprises a distance sensor configured to determine distance from the data recording system to at least one other data recording system in the canopy formation.

5. The system of claim 1, wherein the computing device is further configured to overlay terrain model data upon the generated graphical representation of the canopy formation flight.

6. The system of claim 1, wherein the computing device is further configured to overlay threat model data upon the generated graphical representation of the canopy formation flight.

7. The system of claim 1, wherein the computing device is further configured to determine recommended canopy control inputs for at least one parachutist under canopy, and to transmit the recommended canopy control inputs to the respective data recording system.

8. The system of claim 7, wherein the steps of determining and transmitting recommended canopy control inputs are repeated throughout the duration of the canopy formation flight.

9. The system of claim 1, wherein the computing device is further configured to generate performance indicative data for at least one parachutist under canopy.

10. The system of claim 1, wherein the computing device is further configured to generate performance indicative data for the overall canopy formation.

11. A method for the synthetic visualization of a parachute canopy formation flight, the method comprising:
collecting time-synchronized inertial, position, and altitude data from a data recording system stowed with each parachutist in a canopy formation flight; and
downloading the time-synchronized data from each data recording system to a single computing system; and
visualizing the canopy formation flight by importing the time-synchronized data into a graphics software engine on the computing system.

12. The method of claim 11, wherein inertial data may be collected using any combination of one or more accelerometers and gyroscopes.

13. The method of claim 11, wherein position data may be collected using any combination of one or more GPS and pressure sensors.

14. The method of claim 11, wherein altitude data may be collected using any combination of one or more GPS and pressure sensors.

15. The method of claim 11, wherein visualizing the canopy formation flight includes each parachutist under canopy being visualized relative to the overall formation, along with the inclusion of identifying information to include orientation, altitude, and velocity, and wherein progress along the flight path of each parachutist under canopy may be displayed dynamically from parachute deployment to arrival at the desired impact point.

16. The method of claim 11, wherein the computing device may further comprise a terrain model overlay for inclusion into the synthetic visualization of the canopy formation flight.

17. The method of claim 11, wherein the computing device may further comprise an enemy threat model overlay for inclusion into the synthetic visualization of the canopy formation flight.

18. The method of claim 11, further comprising evaluating the synthetic visualization of the canopy formation flight to generate therefrom performance data suitable for use in evaluating the performance of one or more parachutists in the canopy formation and the overall canopy formation.

19. The method of claim 11, further comprising evaluating the synthetic visualization of the canopy formation flight to generate therefrom recommendations for improving performance on subsequent canopy formation flights.

20. The method of claim 11, further comprising evaluating synthetic visualization data of the canopy formation flight to generate therefrom substantially real-time canopy control input recommendations for one or more parachutists in the canopy formation flight.
